(19) United States
(12) Patent Application Publication
(10) Pub. No.: US 2016/0186807 A1
(43) Pub. Date: Jun. 30, 2016

(54) Functional Component, in Particular for a Motor Vehicle, Method for Producing a Functional Component, and a Motor Vehicle Having a Functional Component

(71) Applicant: Bayerische Motoren Werke Aktiengesellschaft, Muenchen (DE)

(72) Inventor: David KELLER, Muenchen (DE)

(21) Appl. No.: 15/063,599

(22) Filed: Mar. 8, 2016

Related U.S. Application Data
(63) Continuation of application No. PCT/EP2014/073171, filed on Oct. 29, 2014.

(30) Foreign Application Priority Data
Nov. 15, 2013 (DE) 10 2013 223 295.0

(51) Int. Cl. F16C 33/20; B29C 43/20; F16C 17/02; B29C 45/16; B29C 43/18; B29C 45/14

(52) U.S. Cl. CPC F16C 33/205; F16C 33/201; F16C 33/208; B29C 43/18; B29C 45/14622; F16C 17/02; B29C 45/1671; B29C 43/203; B29L 2009/005

(57) ABSTRACT

A functional component, in particular for a motor vehicle is provided. The component has a cured fiber composite molding compound, and at least one rubber bearing integrated into the fiber composite molding component.

### CROSS REFERENCE TO RELATED APPLICATIONS

This application is a continuation of PCT International Application No. PCT/EP2014/073171, filed Oct. 29, 2014, which claims priority under 35 U.S.C. §119 from German Patent Application No. 10 2013 223 295.0, filed Nov. 15, 2013, the entire disclosures of which are herein expressly incorporated by reference.

### BACKGROUND AND SUMMARY OF THE INVENTION

The present invention relates to a functional component, in particular for a motor vehicle, and to a method for producing a functional component. The invention furthermore also relates to a motor vehicle which has at least one functional component.

Functional components, such as node elements in a motor vehicle, for example, for linking to further components, such as control arms and similar, include receptacle provisions or linking functions, respectively. These receptacle provisions and underlying rubber bearings are screwed or pressed into the node elements, which are usually formed from a metallic material, or are connected to the node elements by way of an adhesive connection. The comparatively high dead weight, a complex structure of the node element, and a complex production method are disadvantageous in this type of functional component.

Proceeding from this prior art it is an object of the present invention to provide a stable component having high functionality with a view to bearing further components, while having a simple and simultaneously weight-reduced structure. It is furthermore an object of the invention to provide methods for producing a functional component, which are implementable in a simple manner without high technical complexity and thus also in a cost-effective manner. It is moreover an object of the present invention to provide a motor vehicle offering a high level of ride comfort and good driving dynamics, which is moreover distinguished by a reduced dead weight.

This and other objects are achieved according to the invention by a functional component, in particular for a motor vehicle, wherein the component comprises a cured fiber-composite molding compound, in which at least one rubber bearing is integrated in the fiber-composite molding compound. The cured fiber-composite molding compound, which usually contains at least one reaction resin and fibrous material and, inter alia, is also referred to as SMC (sheet molding compound) or BMC (bulk molding compound), in relation to traditional metallic materials is distinguished by a significantly reduced dead weight while offering very good mechanical stability.

According to the invention, at least one rubber bearing is integrated in the cured fiber-composite molding compound. A rubber bearing in the context of the invention is a receptacle provision or a linking function for further components which, by way of the rubber bearing in the functional component, are mounted in a low-noise and low-vibration manner. The rubber bearing is formed in a conventional way and preferably includes a bearing core and a layer of rubber or a rubber-like material surrounding the bearing core. The components to be linked, that is to say mounted, are incorporated in a clearance in the bearing core, for example. On account of the direct integration of the rubber bearing in the cured fiber-composite molding compound, additional connectors or fasteners may be dispensed with for the arrangement of the rubber bearing. This is made possible in that the rubber bearing is fitted into the fibrous structure of the fiber-composite molding compound and thus becomes an integral component part of the component. In this way, a highly functional component having a linking function or a receptacle provision, respectively, for further components to be mounted, is obtained. The functional component, while having a simple structure, is distinguished by good stability, very good bearing properties, and moreover by a low dead weight. Further components may be disposed in a conventional way on or in the functional component according to the invention.

According to one advantageous refinement of the functional component according to the invention, the rubber bearing is disposed in a clearance in the cured fiber-composite molding compound. This contributes toward the mechanical stability of the functional component, in particular in that region of the cured fiber-composite molding compound in which the rubber bearing is integrated. This is because the fiber-containing material remains substantially undamaged and furthermore a precisely fitting connection between the rubber bearing and the fiber-composite molding compound is obtained when the rubber bearing is inserted or pressed into the fiber-composite molding compound, for example.

The rubber bearing advantageously includes a metallic or plastics-containing outer ring, wherein the outer ring in particular has a first adhesive structure which prevents autonomous detachment of the rubber bearing from the cured fiber-composite molding compound. On account of an outer ring being provided on the rubber bearing, positioning and stabilizing in the cured fiber-composite molding compound may be performed in a particularly simple manner. Advantageous adhesive structures include, for example, barbs, corrugations, or other friction-enhancing structures. This increases the stability of the functional component in the case of forces, such as impact or traction forces, vibrations, or rotation, acting thereon. The first adhesive structure here engages in the fibrous material of the cured fiber-composite molding compound and thus enables particularly good anchoring of the rubber bearing.

Further advantageously, the cured fiber-composite molding compound has a bushing for receiving the rubber bearing. The bushing forms the mating piece for the rubber bearing, in particular for the outer ring of the rubber bearing, such that a very stable integration of the rubber bearing may be achieved with a precise fit in the cured fiber-composite molding compound. The bushing here may be formed from a metallic or plastics-containing material. The material of the bushing is preferably resistant to wear, enabling multiple insertion and detachment of the rubber bearing into and from the bushing, respectively, without causing damage to the supporting structures of the fiber-composite molding compound.

One further advantageous refinement provides that the bushing has a second adhesive structure which comes to engage with the first adhesive structure of the outer ring of the rubber bearing. The second adhesive structure thus forms the mating piece for the first adhesive structure and, by configuring a form-fitting connection, enables particularly good receiving, positioning, and stable adhesion of the rubber bearing in the bushing.

Further advantageously, the bushing has at least one planar region for disposal of a tool for fastening the rubber bearing in the bushing or for detaching the rubber bearing from the bushing. In this way, simple integration of the rubber bearing in the fiber-composite molding compound and furthermore also replacement of the rubber bearing, for example in the case of servicing, may be performed. This can be done without the fiber-composite molding compound being subject to partial deformation or even destruction by pressure or traction forces.

In order for corrosion damage on the component to be prevented, in particular when carbon fibers are used in the fiber-composite molding compound, the bushing is preferably configured so as to be galvanically isolating. This may be implemented by way of a suitable selection of material on the fiber-composite molding compound side and, in particular, on the bushing side.

Furthermore according to the invention, a first method for producing a functional component as has been described above is stated, the method being characterized by the following acts:
providing a fiber-composite molding compound;
curing the fiber-composite molding compound;
forming a clearance in the cured fiber-composite molding compound;
providing a rubber bearing having a metallic or plastics-containing outer ring; and
pressing the rubber bearing into the clearance of the cured fiber-composite molding compound, such that the outer ring of the rubber bearing is integrated into the cured fiber-composite molding compound.

By carrying out the method according to the invention, a highly functional component which is well suited to mounting further components and which is distinguished by a low dead weight and, on account of absent fasteners or connectors between the rubber bearing and the cured fiber-composite molding compound, by a simple structure is obtained in a simple way while using standard processes. On account of the direct integration of the outer ring of the rubber bearing with a precise fit and thus a stable anchoring of the rubber bearing in the fiber-composite molding compound by being pressed in without the use of traditional fastening means or connection elements, the technical and logistical complexity of the method according to the invention is minor, and the cost structure of the latter is optimized. Furthermore, replacement of the rubber bearing is possible in a very simple manner, for example by press extraction of the rubber bearing from the clearance. The first method according to the invention is therefore suitable, in particular, for functional components in which the bearing on account of the construction principle and the use thereof is subject to high wear and therefore needs to be replaced at regular intervals.

The method may be complemented by usual method steps, such as molding the fiber-composite molding compound prior to curing.

The present invention furthermore relates to a second method for producing a functional component as has been described above, the method being characterized by the following acts:
providing a fiber-composite molding compound;
incorporating the fiber-composite molding compound in a tool;
laying up at least one rubber bearing which comprises a metallic or plastics-containing outer ring in the fiber-composite molding compound, such that the outer ring of the rubber bearing comes into contact with the fiber-composite molding compound;
closing the tool;
compressing the fiber-composite molding compound around the rubber bearing; and
curing the fiber-composite molding compound.

The second method according to the invention is also distinguished by being capable of simple implementation, using standard processes. Moreover, the second method for integrating the rubber bearing does not require a post-processing of the cured fiber-composite molding compound, since the rubber bearing is integrated already prior to curing of the fiber-composite molding compound, that is to say in the shape-imparting step for configuring the final shape of the component, as the tool is being closed. In this way the rubber bearing is incorporated even better in the fiber structure of the fiber-composite molding compound. The mounting properties and the mechanical properties of the functional component are thus very good.

A third method for producing a functional component as has been described above is likewise described according to the invention, the method being characterized by the following acts:
providing a fiber-composite molding compound;
forming a clearance in the fiber-composite molding compound; and
creating a rubber bearing in the clearance in the fiber-composite molding compound by way of an injection-molding method, in particular by way of an elastomer injection-molding method.

By way of the third method according to the invention, a component which in terms of its structure is optimized, having very good bearing properties and thus high functionality while offering very good mechanical stability, is likewise obtained in a simple way. On account of the step of creating a rubber bearing in the clearance in the fiber-composite molding compound by way of an injection-molding method, the provision of an outer ring on the rubber bearing may be dispensed with, reducing the logistical and also the technical complexity of the method and leading to a further savings in weight of the component according to the invention. Moreover, an anti-corrosion method is omitted, since the rubber bearing per se ensures galvanic separation. If and when required, calibration of the rubber bearing may be performed by way of a bearing core. According to the third method according to the invention, integrating the rubber bearing into the fiber-composite molding compound is performed simultaneously with producing the rubber bearing, so that the production times for the component according to the invention are shortened and a higher cycle rate in the production process is thus enabled.

The refinements, advantages, and effects which have been described for the component according to the invention may also be applied to the methods according to the invention for producing a functional component.

According to one advantageous refinement of the third method according to the invention for producing a functional component, the method further comprises at least one of the following acts:
curing the fiber-composite molding compound; and
vulcanizing the rubber bearing.

The final shape and structure of the functional component is stabilized by way of the stated method acts and in particular by way of the combination thereof.

It is advantageously provided here that curing of the fiber-composite molding compound and vulcanizing of the rubber bearing, in particular under the influence of temperature, are performed in one step. On account thereof, acceleration of the method and thus shortening of the process times may be achieved.

The invention furthermore relates to a motor vehicle which includes a functional component as has been described above. The motor vehicle according to the invention, on account of the optimal and low-noise mounting properties of the component according to the invention, is distinguished by a high level of ride comfort, very good driving dynamics, and excellent stability at reduced weight.

On account of the achievements according to the invention and the refinements thereof, the following advantages are derived.

The component according to the invention is distinguished by very good mounting properties while having a simple structural construction.

A functional component and a motor vehicle having a reduced dead weight are provided.

On account of the rubber bearing being integrated in the fiber-composite molding compound, the component is distinguished by high stability and very good mechanical properties.

On account of the simplified structure of the component, the latter is producible in a simple manner without high technical complexity and while using standard processes, and thus in a cost-effective manner.

The motor vehicle having the component according to the invention has a high level of ride comfort and very good driving dynamics.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a longitudinal section view through a rubber bearing for use in a functional component according to one embodiment of the invention;

FIG. 2 is a sectional view through a component according to a first advantageous refinement of the invention; and

FIG. 3 is a sectional view through a component according to a second advantageous refinement of the invention.

### DETAILED DESCRIPTION OF THE DRAWINGS

In the figures only those parts of the rubber bearing and of the functional component which are of interest are illustrated; all other elements have been omitted for the sake of clarity. Furthermore, identical reference signs refer to identical components.

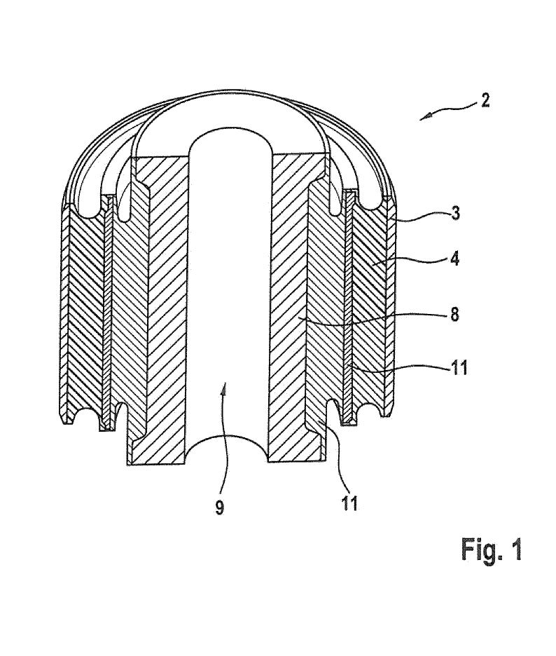

FIG. 1 shows in detail a longitudinal section through a rubber bearing 2 which is suitable in the production of a functional component according to the invention. The rubber bearing includes an outer ring 3, which may be closed or else slotted, for example. An inner layer made from rubber or from a rubber-like material 4, which at least in portions and preferably in a substantially entire manner covers an inner face of the outer ring 3. The rubber bearing also includes a bearing core 8, for example made from a metallic material. The bearing core 8, at least in portions, is disposed on the inner side of the layer of rubber or rubber-like material 4. Further layers which are preferably provided for improving the bearing properties and/or damping properties of the rubber bearing may be present between the bearing core 8 and the layer of rubber or rubber-like material 4. In this way, inserts 11 or alternatively or additionally thereto chambers, cavities, or further layers from rubber or rubber-like material which contribute toward an improved damping effect and reducing vibrations may be optionally provided between the bearing core 8 and the layer of rubber or rubber-like material 4. Here, cavities or chambers may be filled with air or a fluid. Furthermore, the bearing core 8 has a bore 9 which serves for receiving or linking further components to be mounted, such as a motor vehicle control arm, for example.

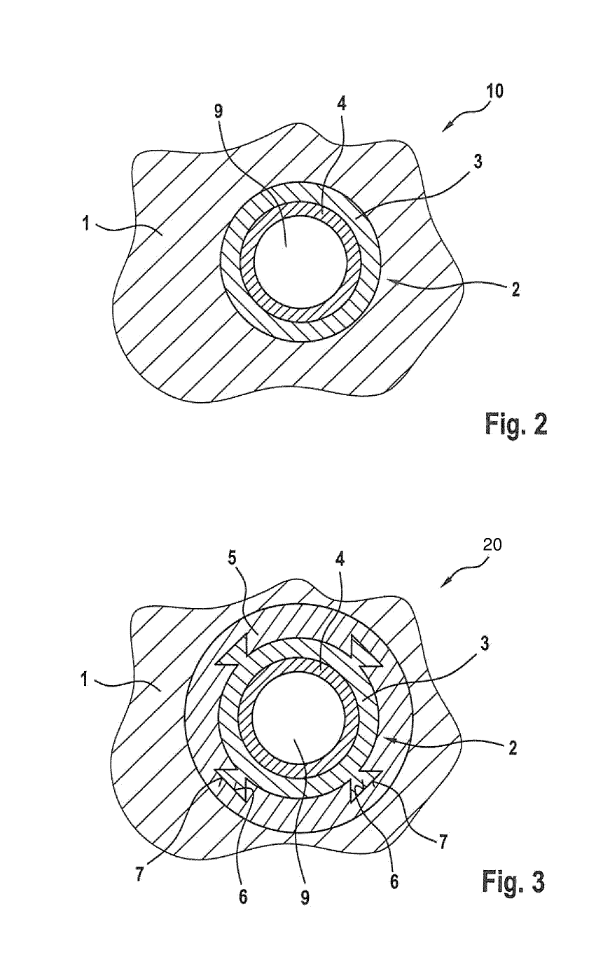

FIG. 2 shows a functional component 10, in particular for a motor vehicle, which includes a cured fiber-composite molding compound 1. A rubber bearing 2 is integrated in the cured fiber-composite molded compound 1. The rubber bearing in this embodiment has an outer ring 3 and an inner layer of rubber or a rubber-like material 4, which in turn has a bore 9. The rubber bearing 2 may furthermore even have a bearing core which at least in portions is disposed on the inner side of the layer of rubber or rubber-like material 4. The rubber bearing 2 in turn provides a linking function or a receptacle provision, respectively, for a component to be mounted, and is provided for receiving and mounting a motor vehicle control arm in a low-noise and low-vibration manner, for example.

The rubber bearing 2 is integrated in the cured fiber-composite molding compound 1 and, for example, is pressed into the fiber-composite compound. On account thereof, good bonding between the rubber bearing 2 and the cured fiber-composite molding compound 1 is obtained, and the rubber bearing 2 is fixed in its position and stabilized in relation to mechanical forces, for example traction forces, torsion forces, or vibrations, acting thereon. The outer ring 3 of the rubber bearing here may be formed from a metallic material or a plastics-containing material. Use of a plastics-containing material here offers the advantage of additionally providing a integral material connection between the rubber bearing 2 and the cured fiber-composite molding compound 1.

The rubber bearing 2 may advantageously be disposed in a clearance in the cured fiber-composite molding compound 1.

The functional component 20 which is shown in FIG. 3 likewise has a rubber bearing 2 which is integrated in a cured fiber-composite molding compound 1. In comparison with the functional component 10 from FIG. 2, a bushing 5, which may be formed for example from metal or a plastics-containing material, is incorporated into the cured fiber-composite molding compound 1. The bushing 5 serves for receiving, positioning, and fixing the rubber bearing 2 in the cured fiber-composite molding compound 1.

To this end, the rubber bearing 1 additionally has a first adhesive structure 6. The first adhesive structure 6 in this embodiment is configured in an exemplary manner in the form of dovetail structures but may have any shape which supports friction between the rubber bearing 2 and the cured fiber-composite molding compound 1. The dovetail shape shown here has the additional advantage that a particularly stable and form-fitting connection is formed between the first adhesive structure 6 of the rubber bearing 2, which is disposed on the outer ring 3 of the rubber bearing 2, and a second adhesive structure 7 which is provided on the inner side of the bushing 5. The first adhesive structure 6 of the rubber bearing 2, and the second adhesive structure 7 of the bushing 5 form respective mating pieces which are mutually adapted in a precise fit, so that good integration and anchoring of the rubber bearing 2 in the fiber-composite molding compound 1 may be guaranteed.

Furthermore, the bushing 5 may have at least one planar region for disposal of a tool for fastening the rubber bearing 2 in the bushing 5, or for detaching the rubber bearing 2 from the bushing 5.

### LIST OF REFERENCE SIGNS

1 Cured fiber-composite molding compound
2 Rubber bearing
3 Outer ring of the rubber bearing
4 Layer from rubber or a rubber-like material
5 Bushing
6 First adhesive structure
7 Second adhesive structure
8 Bearing core
9 Bore
10, 20 Functional component
11 Insert

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A functional component, comprising:
a cured fiber-composite molding compound; and
at least one rubber bearing integrated in the fiber-composite molding compound.

2. The functional component according to claim 1, wherein the rubber bearing is disposed in a clearance in the cured fiber-composite molding compound.

3. The functional component according to claim 1, wherein
the rubber bearing comprises a metallic or plastics-containing outer ring,
the outer ring has a first adhesive structure configured to prevent autonomous detachment of the rubber bearing from the cured fiber-composite molding compound.

4. The functional component according to claim 1, further comprising a bushing of the cured fiber-composite molding compound, the bushing being configured to receive the rubber bearing.

5. The functional component according to claim 3, further comprising a bushing of the cured fiber-composite molding compound, the bushing being configured to receive the rubber bearing.

6. The functional component according to claim 5, wherein the bushing has a second adhesive structure configured to engage with the first adhesive structure of the outer ring of the rubber bearing.

7. The functional component according to claim 4, wherein the bushing comprises at least one planar region configured such that a tool for fastening the rubber bearing in the bushing or detaching the rubber bearing from the bushing is disposable thereon.

8. The functional component according to claim 4, wherein the bushing is configured to provide galvanic isolation.

9. The functional component according to claim 1, wherein the component is a motor vehicle functional component.

10. A method for producing a functional component, the method comprising the acts of:
providing a fiber-composite molding compound;
curing the fiber-composite molding compound;
forming a clearance in the cured fiber-composite molding compound;
providing a rubber bearing having a metallic or plastics-containing outer ring; and
pressing the rubber bearing into the clearance of the cured fiber-composite molding compound, wherein an outer ring of the rubber bearing is integrated into the cured fiber-composite molding compound.

11. A method for producing a functional component, the method comprising the acts of:
providing a fiber-composite molding compound;
incorporating the fiber-composite molding compound in a tool;
inserting at least one rubber bearing which comprises a metallic or plastics-containing outer ring in the fiber-composite molding compound, wherein the outer ring (3) of the rubber bearing comes into contact with the fiber-composite molding compound;
closing the tool;
compressing the fiber-composite molding compound around the rubber bearing; and
curing the fiber-composite molding compound.

12. A method for producing a functional component, the method comprising the acts of:
providing a fiber-composite molding compound;
forming a clearance in the fiber-composite molding compound; and
creating a rubber bearing in the clearance in the fiber-composite molding compound by way of an injection-molding method.

13. The method according to claim 12, wherein the injection-molding method is an elastomer injection-molding method.

14. The method according to claim 12, further comprising the acts of:
curing the fiber-composite molding compound; and
vulcanizing the rubber bearing.

15. The method according to claim 14, wherein the act of curing and vulcanizing are performed in one step.

16. A motor vehicle comprising at least one functional component according to claim 1.
